(19) United States
(12) Patent Application Publication
(10) Pub. No.: US 2024/0023531 A1
(43) Pub. Date: Jan. 25, 2024

(54) Retractable Fishing Tip-Up Device

(71) Applicant: Matt Larsen, Wyoming, MN (US)

(72) Inventor: Matt Larsen, Wyoming, MN (US)

(21) Appl. No.: 18/342,924

(22) Filed: Jun. 28, 2023

Related U.S. Application Data
(60) Provisional application No. 63/390,455, filed on Jul. 19, 2022.

(51) Int. Cl. A01K 97/01; A01K 97/12

(52) U.S. Cl. CPC A01K 97/01; A01K 97/125

(57) ABSTRACT

An ice fishing tip-up device is disclosed that provides an improved, retractable ice fishing tip-up device that allows the user to fish hands-free. The ice fishing tip-up device comprises a base component that supports a wheel component. The wheel component is secured to the base component, such that the wheel component can rotate on the base component during use. The wheel component supports a fishing line and allows a user to retract the fishing line gently while the fish remains on the line to prevent line breaks. Generally, the user retracts the fishing line via a handle secured to the wheel component, which allows the wheel component to rotate.

### CROSS-REFERENCE TO RELATED APPLICATION

The present application claims priority to, and the benefit of, U.S. Provisional Application No. 63/390,455, which was filed on Jul. 19, 2022, and is incorporated herein by reference in its entirety.

### FIELD OF THE INVENTION

The present invention relates generally to the field of ice fishing tip-up devices. More specifically, the present invention relates to a retractable ice fishing tip-up to facilitate hands free fishing. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in ice fishing tip-up devices. Generally, standard tip-up designs that anglers use can be frustrating to operate. Retracting the fishing line from the tip-up can be difficult without getting excessively wet. Further, if the line is tugged too hard, it may break and release the fish.

Ice fishing remains a pleasurable past time for many in polar climates. Ice fishing is mostly done on ice above shallow water. In colder climates, in many instances, deeper water can also be fished. In these cases, having an excess of line is cumbersome to the fisherman as line is dropped into the hole and pulled out by hand or via a pole. After the line is dropped into the hole, the fisherman waits for a fish to take bait from the end of a hook attached to the line. The pull of the fish on the line alerts the fisherman that a fish is on the line. The fisherman then pulls the line from the water and retrieves the fish. However, pulling the line can result in breakage of the line, which releases the fish.

Accordingly, there is a demand for an improved ice fishing tip-up device that allows for hands-free fishing. More particularly, there is a demand for a device that gently retracts the fishing line to prevent breaks and reduce mess associated with ice fishing tip-ups.

Therefore, there exists a long-felt need in the art for an ice fishing tip-up device that provides users with a retractable ice fishing tip-up to facilitate hands-free fishing. There is also a long-felt need in the art for an ice fishing tip-up device that features a wheel mechanism that gently retracts the fishing line to prevent breaks. Further, there is a long-felt need in the art for an ice fishing tip-up device that reduces mess associated with ice fishing tip-ups, offering easier and convenient clean up. Moreover, there is a long-felt need in the art for a device that improves the overall fishing experience and increases the chances of catching more fish throughout the day. Further, there is a long-felt need in the art for an ice fishing tip-up device that can be easily set up and compacted for storage and transportation. Finally, there is a long-felt need in the art for an ice fishing tip-up device that can vary in size and construction.

The subject matter disclosed and claimed herein, in one embodiment thereof, comprises an ice fishing tip-up device. The device is an improved, retractable ice fishing tip-up device that allows the user to fish hands-free. The ice fishing tip-up device comprises a base component that supports a wheel component. The wheel component is secured to the base component, such that the wheel component can rotate on the base component during use. The wheel component supports a fishing line and allows a user to retract the fishing line gently, while the fish remains on the line, to prevent line breaks. Generally, the user retracts the fishing line via a handle secured to the wheel component, which allows the wheel component to rotate. The wheel component can also include a stop or a brake, which allows the wheel component to stop rotating and retain the fishing line in a set position. Thus, the device prevents unwanted mess and provides for easier cleanup. Further, the device can be easily set up and compacted for storage and transportation.

In this manner, the ice fishing tip-up device of the present invention accomplishes all of the foregoing objectives and provides users with a device that allows a user to fish hands-free. The device gently retracts a fishing line, preventing line breaks. The device provides for easy set-up and take-down.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form, as a prelude to the more detailed description that is presented later.

The subject matter disclosed and claimed herein, in one embodiment thereof, comprises an ice fishing tip-up device. The device is an improved, retractable ice fishing tip-up device that allows the user to fish hands-free. The ice fishing tip-up device comprises a base component that supports a wheel component. The wheel component is secured to the base component, such that the wheel component can rotate on the base component during use. The wheel component supports a fishing line and allows a user to retract the fishing line gently, while the fish remains on the line, to prevent line breaks. Thus, the device prevents unwanted mess and provides for easier cleanup.

Generally, tip-ups are ice fishing devices designed to suspend a fishing line with a baited hook through an ice hole, and to alert a user when a fish takes the bait. In most cases, this is achieved with a flag attached to a spring. When a fish grabs the bait, this causes the line spool to rotate, which in turn, releases the flag and causes it to pop up. While all tip-ups share this basic function, they come in a wide variety of shapes, sizes, and designs. Tip-ups are designed to work without a fishing rod, and so you need to fight the fish by pulling the line manually, hand over hand.

In one embodiment, the ice fishing tip-up device comprises a base component that can be any suitable shape and size as is known in the art. The base component can take a variety of forms including legs or platforms sufficient to steady the device while in use. Generally, the base component is rectangular in shape and comprises a top surface, a bottom surface, right and left opposing sides, and front and back opposing sides.

In one embodiment, the base component comprises a rail-style design consisting of two parallel pieces of wood or plastic that form a rail, which is then placed on top of an ice hole. In another embodiment, instead of two parallel pieces, a single flat board is utilized and placed on top of an ice hole. In either embodiment, a metal rod is positioned perpendicular to the rails or single board, and acts to hold the wheel component at one end of the base component (to be inserted by the edge of the ice hole). The wheel component is secured to the metal rod via any suitable securing means as is known in the art, such as pins, bolts, welding, etc.

In one embodiment, the base component supports the wheel component via a pair of trunnions secured to either side of the metal rod of the base component, via welding, pins, bolts, etc. Further, the trunnions secure to a mounting bracket on the wheel component and an axel, which allows a focus for rotation of the wheel component.

In one embodiment, a spring with a flag (i.e., the bite indicator) is located at one end of the rails or board and attached to a rotating trip bar of the mounting bracket of the wheel component. When a fish takes the bait, the rotating trip bar triggers the flag to spring up. Accordingly, in one embodiment, the bite indicator is a brightly colored flag, secured via the spring, such that when the wheel component rotates, the flag is released and pops up, alerting a user that a fish is on the line. In another embodiment, the bite indicator is a bell that creates an audible signal. In yet another embodiment, the bite indicator is an electronic mechanism that sends a text message to your smart phone. Accordingly, using a non-visual signal can be helpful if you want to wait for bites inside the comfort of an ice fishing shelter or other area.

In one embodiment, the wheel component comprises a handle or other suitable means for manually turning the wheel component to retract the fishing line. The handle can be any suitable handle as is known in the art and is secured at one end of the axel of the wheel component to allow a user to manually rotate the wheel component. Generally, the user retracts the fishing line via the handle, which allows the wheel component to rotate and retract the fishing line gently without worry of the fishing line breaking. Further, the handle locks the trigger in place to set the hook on the fish.

In one embodiment, a brake or rotational stop is generally provided above the trunnions on the wheel component to limit the rotational travel of the fishing line once the fishing line is in a predetermined position. Thus, the brake or rotational stop allows the wheel component to stop rotating and retain the fishing line in a set position.

In one embodiment, the wheel component can be separated from the base component, allowing the device to be easily compacted and stored when not in use. Thus, the ice fishing tip-up device can be easily set up and compacted for storage and transportation, as needed.

In operation, a user begins by spooling the tip-up device with the right pound test line for the kind of fish you want to catch. Thus, a specific fishing line is wound around the wheel component of the device. The fishing line can be anywhere from 75-100 feet long, depending on the area where the user is fishing and depending on what type of fish the user wants to catch. Next, a user drills a hole in the ice, and checks for depth. Afterwards, a user baits the hook and lowers the hook and fishing line into the ice hole. Specifically, the fishing line and hook are lowered down to a designated depth with the tip-up device straddling the ice hole and the wheel component positioned at an edge of the ice hole. A user then lowers the flag of the tip-up device and attaches it to the rotating trip bar of the wheel component. Finally, a user adjusts the trigger sensitivity of the device. Typically, a user would want to make the device as sensitive as possible without triggering the flag unnecessarily. If the sensitivity is too heavy, a fish taking the bait will feel resistance, and is likely to spit out the bait, but if the sensitivity is too light, your bait fish may be able to trigger the flag. Once the trigger sensitivity is set, the user waits for a fish to bite and the flag to be triggered.

In one embodiment, the ice fishing tip-up device is generally manufactured of wood, plastic, metal, etc., or any other suitable materials as is known in the art. In one embodiment, the base component and the wheel component are made of different materials. In another embodiment, the base component and the wheel component are made of the same materials. In another embodiment, the ice fishing tip-up device is made of water resistant or waterproof materials or comprises a coating of water resistant or waterproof materials.

In yet another embodiment, the ice fishing device comprises a plurality of indicia.

In yet another embodiment, a method of retracting a fishing line without worry of line breaks during ice fishing is disclosed. The method includes the steps of providing an ice fishing tip-up device comprising a base component that supports a wheel component, wherein the wheel component rotates on the base component during use to retract a fishing line gently. The method also comprises threading a fishing line onto the wheel component for use. Further, the method comprises dropping the fishing line into the fishing hole to ice fish. Finally, the method comprises, once a fish is on the line, retracting the fishing line via the wheel component, without worry of breaking the fishing line.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the ice fishing tip-up device of the present invention showing the device in use in accordance with the disclosed architecture;

FIG. 2 illustrates a front perspective view of one embodiment of the ice fishing tip-up device of the present invention showing the base component secured to the wheel component in accordance with the disclosed architecture; and

FIG. 3 illustrates a flowchart showing the method of retracting a fishing line without worry of line breaks during ice fishing in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an ice fishing tip-up device that provides users with a retractable ice fishing tip-up to facilitate hands-free fishing. There is also a long-felt need in the art for an ice fishing tip-up device that features a wheel mechanism that gently retracts the fishing line to prevent breaks. Further, there is a long-felt need in the art for an ice fishing tip-up device that reduces mess associated with ice fishing tip-ups, offering easier and convenient clean up. Moreover, there is a long-felt need in the art for a device that improves the overall fishing experience and increases the chances of catching more fish throughout the day. Further, there is a long-felt need in the art for an ice fishing tip-up device that can be easily set up and compacted for storage and transportation. Finally, there is a long-felt need in the art for an ice fishing tip-up device that can vary in size and construction.

The present invention, in one exemplary embodiment, is a novel ice fishing tip-up device. The device is an improved, retractable ice fishing tip-up device that allows the user to fish hands-free. The ice fishing tip-up device comprises a base component that supports a wheel component. The wheel component is secured to the base component, such that the wheel component can rotate on the base component during use. The wheel component supports a fishing line and allows a user to retract the fishing line gently, while the fish remains on the line, to prevent line breaks. Generally, the user retracts the fishing line via a handle secured to the wheel component, which allows the wheel component to rotate. The present invention also includes a novel method of retracting a fishing line without worry of line breaks during ice fishing. The method includes the steps of providing an ice fishing tip-up device comprising a base component that supports a wheel component, wherein the wheel component rotates on the base component during use to retract a fishing line gently. The method also comprises threading a fishing line onto the wheel component for use. Further, the method comprises dropping the fishing line into the fishing hole to ice fish. Finally, once a fish is on the line, the method comprises a step of retracting the fishing line via the wheel component without worry of breaking the fishing line.

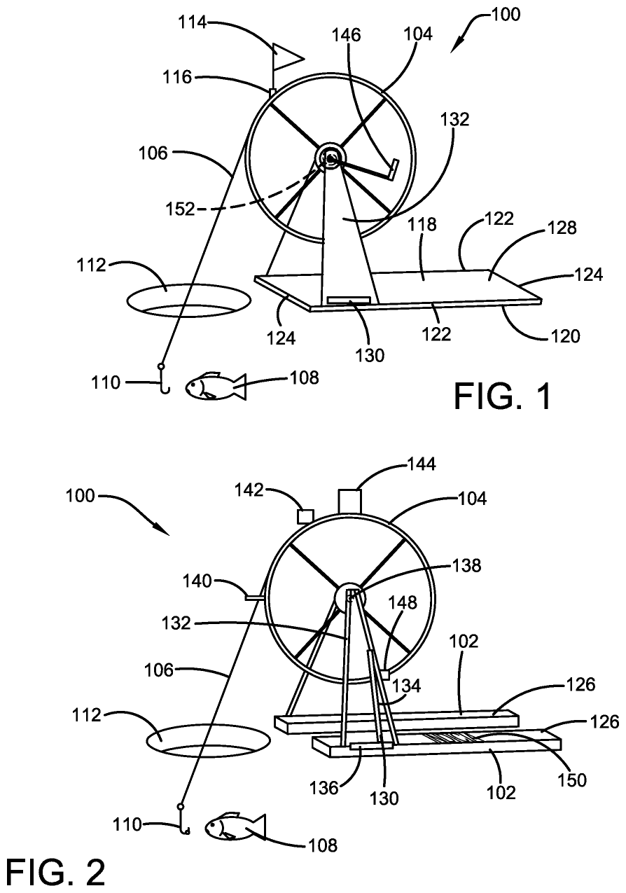

Referring initially to the drawings, FIGS. 1-2 illustrate a perspective view of one embodiment of the ice fishing tip-up device 100 of the present invention. In the present embodiment, the ice fishing tip-up device 100 is an improved ice fishing tip-up device 100 that facilitates hands-free ice fishing. Further, the device 100 is a retractable ice fishing tip-up device. Specifically, the ice fishing tip-up device 100 comprises a base component 102 that supports a wheel component 104. The wheel component 104 is secured to the base component 102, such that the wheel component 104 can rotate on the base component 102 during use. The wheel component 104 supports a fishing line 106 and allows a user to retract the fishing line 106 gently, while the fish 108 remains on the line 106, to prevent line breaks. Thus, the device 100 prevents unwanted mess and provides for easier cleanup while ice fishing.

Generally, tip-ups are ice fishing devices designed to suspend a fishing line 106 with a baited hook 110 through an ice hole 112, and to alert a user when a fish 108 takes the bait. In most cases, this is achieved with a flag 114 attached to a spring 116. When a fish 108 grabs the bait, this causes a line spool to rotate, which in turn, releases the flag 114 and causes it to pop up. While all tip-ups share this basic function, they come in a wide variety of shapes, sizes, and designs. Tip ups are designed to work without a fishing rod, and so you need to fight the fish 108 by pulling the line 106 in manually, hand over hand.

Further, the ice fishing tip-up device 100 comprises a base component 102 that can be any suitable shape and size as is known in the art. The base component 102 can take a variety of forms including legs or platforms sufficient to steady the device 100 while in use. Generally, the base component 102 is rectangular in shape and comprises a top surface 118, a bottom surface 120, right and left opposing sides 122, and front and back opposing sides 124.

In one embodiment, the base component 102 comprises a rail-style design, consisting of two parallel pieces 126 of wood or plastic that form a rail which is then placed on top of an ice hole 112 (as shown in FIG. 2). In another embodiment, instead of two parallel pieces 126, a single flat board 128 is utilized and placed on top of an ice hole 112 (as shown in FIG. 1). In either embodiment, a metal rod 130 is positioned perpendicular to the rails 126 or single board 128 and acts to hold the wheel component 104 at one end 130 of the base component 102 (to be inserted by the edge of the ice hole 112). The wheel component 104 is secured to the metal rod 130 via any suitable securing means as is known in the art, such as pins, bolts, welding, etc., (as shown in FIGS. 1-2).

Additionally, the base component 102 supports the wheel component 104 via a pair of trunnions 132 or other suitable components secured to either side 134 of the metal rod 130 of the base component 102 via welding, pins, bolts, etc. Further, the trunnions 132 secure to a mounting bracket 136 on the wheel component 104 and an axel 138, which allows a focus for rotation of the wheel component 104. The wheel component 104 freely rotates on the axel 138 during use.

In one embodiment, a spring 116 with a flag 114 (i.e., the bite indicator) is located at one end of the rails 126 or board 128 and attached to a rotating trip bar 140 of the mounting bracket 136 of the wheel component 104. When a fish 108 takes the bait, the rotating trip bar 140 triggers the flag 114 to spring up. Accordingly, in one embodiment, the bite indicator is a brightly colored flag 114, secured via the spring 116, such that when the wheel component 104 rotates, the flag 114 is released and pops up, alerting a user of a fish 108 on the line 106. In another embodiment, the bite indicator is a bell 142 that creates an audible signal. In yet another embodiment, the bite indicator is an electronic mechanism 144 that sends a text message to your smart phone. Accordingly, using a non-visual signal can be helpful if you want to wait for bites inside the comfort of an ice fishing shelter or other suitable area.

In another embodiment, the wheel component 104 comprises a handle 146 or other suitable means for manually turning the wheel component 104 to retract the fishing line 106. The handle 146 can be any suitable handle as is known in the art and is secured at one end of the axel 138 of the wheel component 104 to allow a user to manually rotate the wheel component 104. Generally, the user retracts the fishing line 106 via the handle 146, which allows the wheel component 104 to rotate and retract the fishing line 106 gently without worry of the fishing line 106 breaking. Further, the handle 146 locks the trigger in place to set the hook on the fish.

In yet another embodiment, a brake or rotational stop 148 is provided generally above the trunnions 132 on the wheel component 104 to limit the rotational travel of the fishing line 106 once the fishing line 106 is in a predetermined position. Thus, the brake or rotational stop 148 allows the wheel component 104 to stop rotating and retain the fishing line 106 in a set position.

Generally, the wheel component 104 can be separated from the base component 102 allowing the device 100 to be easily compacted and stored when not in use. Thus, the ice fishing tip-up device 100 can be easily set up and compacted for storage and transportation, as needed.

In operation, a user begins by spooling the tip-up device 100 with the right pound test line 106 for the kind of fish 108 they want to catch. Thus, a specific fishing line 106 is wound around the wheel component 104 of the device 100. The fishing line 106 can be anywhere from feet long, depending on the area where the user is fishing and depending on what type of fish 108 the user wants to catch. Next, a user drills a hole 112 in the ice, and checks for depth. Afterwards, a user baits the hook 110 and lowers the hook 110 and fishing line 106 into the ice hole 112. Specifically, the fishing line 106 and hook 110 are lowered down to a designated depth with the tip up device 100 straddling the ice hole 112 and the wheel component 104 positioned at an edge of the ice hole 112. A user then lowers the flag 114 of the tip-up device 100 and attaches it to the rotating trip bar 140 of the wheel component 104. Finally, a user adjusts the trigger sensitivity of the device 100. Typically, a user would want to make the device 100 as sensitive as possible without triggering the flag 114 unnecessarily. If the sensitivity is too heavy, a fish 108 taking the bait will feel resistance and is likely to spit out the bait, but if the sensitivity is too light, your bait fish may be able to trigger the flag 114. Once the trigger sensitivity is set, the user waits for a fish 108 to bite and the flag 114 to be triggered.

Furthermore, the ice fishing tip-up device 100 is generally manufactured of wood, plastic, metal, etc., or any other suitable materials as is known in the art. In one embodiment, the base component 102 and the wheel component 104 are made of different materials. In another embodiment, the base component 102 and the wheel component 104 are made of the same materials. In another embodiment, the ice fishing tip-up device 100 is made of water resistant or waterproof materials or comprises a coating of water resistant or waterproof materials.

In yet another embodiment, the ice fishing device 100 comprises a tape measure spring 152 or other measuring device and a plurality of indicia 150. The base component 102 of the device 100 may include advertising, a trademark, or other letters, designs, or characters, printed, painted, stamped, or integrated into the base component 102, or any other indicia 150 as is known in the art. Specifically, any suitable indicia 150 as is known in the art can be included, such as, but not limited to, patterns, logos, emblems, images, symbols, designs, letters, words, characters, animals, advertisements, brands, etc., that may or may not be ice fishing, tip-up, or brand related.

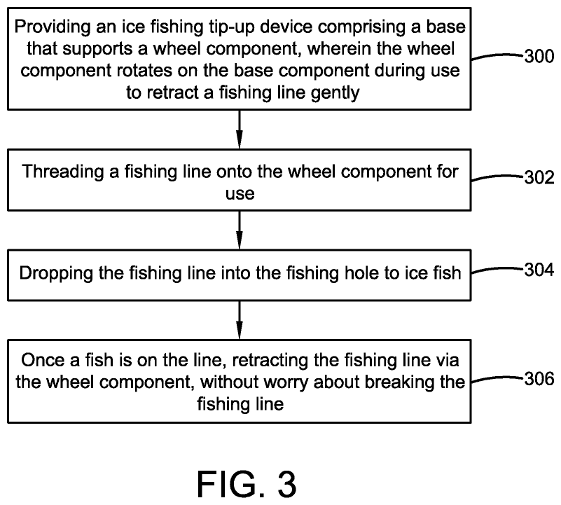

FIG. 3 illustrates a flowchart of the method of retracting a fishing line without worry of line breaks during ice fishing. The method includes the steps of at 300, providing an ice fishing tip-up device comprising a base component that supports a wheel component, wherein the wheel component rotates on the base component during use to retract a fishing line gently. The method also comprises at 302, threading a fishing line onto the wheel component for use. Further, the method comprises at 304, dropping the fishing line into the fishing hole to ice fish. Finally, the method comprises at 306, once a fish is on the line, retracting the fishing line via the wheel component without worry of breaking the fishing line. The wheel component 104 may also snap back to help set the fish on the hook.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “ice fishing tip-up device”, “tip-up device”, “ice fishing device”, and “device” are interchangeable and refer to the ice fishing tip-up device 100 of the present invention.

Notwithstanding the foregoing, the ice fishing tip-up device 100 of the present invention can be of any suitable size and configuration as is known in the art without affecting the overall concept of the invention, provided that it accomplishes the above-stated objectives. One of ordinary skill in the art will appreciate that the ice fishing tip-up device 100 as shown in FIGS. 1-3 are for illustrative purposes only, and that many other sizes and shapes of the ice fishing tip-up device 100 are well within the scope of the present disclosure. Although the dimensions of the ice fishing tip-up device 100 are important design parameters for user convenience, the ice fishing tip-up device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ice fishing tip-up device that facilitates hands-free ice fishing, the ice fishing tip-up device comprising:
a base component; and
a wheel component;
wherein the base component supports the wheel component near an ice fishing hole; and
further wherein the wheel component supports a fishing line and allows a user to retract the fishing line gently, while a fish is on the fishing line, without worry of line breaks.

2. The ice fishing tip-up device of claim 1, wherein the base component is rectangular in shape and comprises a top surface, a bottom surface, right and left opposing sides, and front and back opposing sides.

3. The ice fishing tip-up device of claim 2, wherein the base component comprises a single flat board placed on top of the ice fishing hole.

4. The ice fishing tip-up device of claim 3, wherein a metal rod is positioned perpendicular to the single flat board and acts to hold the wheel component at one end of the base component.

5. The ice fishing tip-up device of claim 4, wherein the base component supports the wheel component via a pair of trunnions, secured to either side of the metal rod of the base component.

6. The ice fishing tip-up device of claim 5, wherein the pair of trunnions secure to a mounting bracket on the wheel component and an axel, which allows a focus for rotation of the wheel component.

7. The ice fishing tip-up device of claim 6, wherein a spring with a flag is located at one end of the single flat board and attached to a rotating trip bar of the mounting bracket of the wheel component.

8. The ice fishing tip-up device of claim 7, wherein when a fish takes bait, the rotating trip bar triggers the flag to spring up.

9. The ice fishing tip-up device of claim 8, wherein instead of a flag, a bell is used to create an audible signal.

10. The ice fishing tip-up device of claim 8, wherein instead of a flag, an electronic mechanism sends a text message to a user's smart phone.

11. The ice fishing tip-up device of claim 8, wherein the wheel component comprises a handle for manually turning the wheel component to retract the fishing line.

12. The ice fishing tip-up device of claim 11, wherein the wheel component comprises a rotational stop to limit rotational travel of the fishing line, once the fishing line is in a predetermined position.

13. An ice fishing tip-up device that facilitates hands-free ice fishing, the ice fishing tip-up device comprising:
a base component which is rectangular in shape and comprises a top surface, a bottom surface, right and left opposing sides, and front and back opposing sides; and
a wheel component;
wherein the base component supports the wheel component near an ice fishing hole;
wherein the base component comprises a single flat board placed on top of the ice fishing hole;
wherein a metal rod is positioned perpendicular to the single flat board and acts to hold the wheel component at one end of the base component;
wherein the base component supports the wheel component via a pair of trunnions, secured to either side of the metal rod of the base component;
wherein the pair of trunnions secure to a mounting bracket on the wheel component and an axel, which allows a focus for rotation of the wheel component;
wherein a spring with a flag is located at one end of the single flat board and attached to a rotating trip bar of the mounting bracket of the wheel component;
wherein when a fish takes bait, the rotating trip bar triggers the flag to spring up; and
wherein the wheel component supports a fishing line and allows a user to retract the fishing line gently, while a fish is on the fishing line, without worry of line breaks.

14. The ice fishing tip-up device of claim 13 further comprising a plurality of indicia and a tape measure spring.

15. The ice fishing tip-up device of claim 13, wherein the wheel component can be separated from the base component, allowing the ice fishing tip-up device to be easily compacted and stored when not in use.

16. The ice fishing tip-up device of claim 13, wherein instead of a flag, a bell is used to create an audible signal.

17. The ice fishing tip-up device of claim 13, wherein instead of a flag, an electronic mechanism sends a text message to a user's smart phone.

18. The ice fishing tip-up device of claim 13, wherein the wheel component comprises a handle for manually turning the wheel component to retract the fishing line.

19. The ice fishing tip-up device of claim 18, wherein the wheel component comprises a rotational stop to limit rotational travel of the fishing line, once the fishing line is in a predetermined position.

20. A method of retracting a fishing line without worry of line breaks during ice fishing, the method comprising the following steps:
providing an ice fishing tip-up device comprising a base component that supports a wheel component, wherein the wheel component rotates on the base component during use to retract a fishing line gently;
threading a fishing line onto the wheel component for use;
dropping the fishing line into the fishing hole to ice fish; and
once a fish is on the line, retracting the fishing line via the wheel component, without worry of breaking the fishing line.
